(19) United States
(12) Patent Application Publication
(10) Pub. No.: US 2007/0257030 A1
(43) Pub. Date: Nov. 8, 2007

(54) MICROWAVEABLE PACKAGE

(75) Inventors: Boon Eow Phee, Penang (MY); Boon Chee Phee, Penang (MY)

Correspondence Address: GRAY, PLANT, MOOTY, MOOTY & BENNETT, P.A., P.O. BOX 2906, MINNEAPOLIS, MN, 55402-0906, US

(73) Assignee: SIN SHEN KUANG SDN BHD, Penang (MY)

(21) Appl. No.: 11/776,959

(22) Filed: Jul. 12, 2007

Related U.S. Application Data
(62) Division of application No. 10/496,003, filed on May 28, 2004.

(30) Foreign Application Priority Data
Apr. 11, 2002 (MY) P120021332
Dec. 7, 2001 (MY) P120015590

(51) Int. Cl. H05B 6/80

(52) U.S. Cl. 219/725

(57) ABSTRACT

This invention relates to the application of flexible films to form an openable sealing means on packages. In particular, the invention relates to the application of flexible films to form an openable sealing means on packages for containing food that are intended to be being heated by microwave ovens. The current invention is a simpler and a more convenient solution to contain the food by packaging that will enable the food to be heated without the need of puncturing the packaging prior to heating.

### CROSS REFERENCE TO RELATED APPLICATIONS

This application is a divisional application of U.S. Utility patent application Ser. No. 10/496,003 filed May 28, 2004; which application is a US national stage application of the International Application No. PCT/SG02/00087 filed on May 13, 2002.

### FIELD OF INVENTION

This invention relates to a package. In particular, the invention relates to a package having pre-designated area(s) of sealing weakness in which upon an increase in temperature or relative pressure inside the package will rupture the pre-designated area(s) to create aperture(s).

### BACKGROUND OF INVENTION

Ready prepared meals that are intended to be reheated using microwave oven are becoming increasingly popular. The food is initially prepared by the manufacturer, and is then placed in a package, which is then wrapped frozen or packaged for freshness and handled for distribution and sale.

During the heating of the food, the moisture content of the food is rapidly heated and transformed into steam. As the temperature of the package increases during heating, the pressure within the package increases due to the expansion of the water molecule. This will sometimes cause the package to explode, spattering the food in the microwave oven, or explode when the package is opened.

To avoid this from happening, consumers usually pierce holes on the package to allow the steam to escape from the container during heating. However, sometimes the punctured holes may be exceedingly large in size, or numerous, and hence too much steam may escape through the holes during heating thus causing the food to be dry after heating. On the other hand, the punctured holes may be exceedingly small or too few in amount, and hence, much of the steam is still trapped and the spattering of food may still occur when the package is opened or when the package explodes. Either way it is likely to result in the food packaging becoming unpalatable.

Thus, the object of the present invention is to provide a package which will enable the object to be heated without the need of puncturing the package prior to heating which may dry the object during heating and or spattering of object to occur

Prior inventions to overcome this problem are sighted.

U.S. Pat. No. 4,461,420 to Horvath Laszlo S. discloses a ventable package cover for packages, consisting of a valve film welded to the inner surface of the capping film of the package. The valve can only be exposed when the capping film is torn off along a predetermined rupture line. The valve film may be permeable to water vapor but impermeable to water.

WO 9959897 to Read M. Peter and Smith B. John discloses a food container and also relates to a film for sealing foods and food containers and to a method of manufacturing a food container. The seal or film for sealing the food containers of this invention consists of 2 layers, a continuous layer and an apertured layer. These two layers are placed in close proximity, wherein they are joined together by means of adhesive or heat bonding. The apertured layer consists of 2% to 50% of apertures with the size of 1-10 mm in diameter, spaced 1-10 mm apart. When the food is to be cooked, the continuous layer is peeled off from the apertured layer, exposing the apertured layer.

GB 2213689 to Griffin C. John discloses a microwave container that has a splashguard or cover which allows the escape of steam from the food contained during cooking or reheating. The cover of this particular invention has holes that are spread over a large area of the cover, thus enabling venting of the steam to occur.

PCT/NZ98/00195 to Tang, Luen and Sing discloses bags, packages or packaging material for containing food or beverages which can be easily torn, without the need for scissors. The bag is multi layered, wherein the inner layer contains at least one line of weakness with the outer layer being substantially intact along the line of weakness and tearable along the line of weakness and the line of weakness extends from the first edge of the bag to the other edge. The line of weakness may be a perforated line, or a dot-dash perforation, or any interruption in the inner layer which substantially disconnects the two portions either side of the weakness. Alternatively, the line of weakness may be a zone which is thinner and/or weaker than the rest of the inner layer. To facilitate the initiation of tear, small opening, break, nick, notch or the like is located along the first edge of the bag.

PCT/NZ00/00180 also to Tang, Luen and Sing discloses a packaging and/or openable sealing means for packaging. The openable sealing means for this invention consists of preferably 3 layers, whereby the first layer is a continuous layer with lines of weakness (i.e. lines of perforations or lines of reduced gauge or a cut), second layer consisting of apertures, and an optional third layer covering the first layer also consisting the lines of weakness. The first and third layer is removed along the line of weakness prior to the heating of the food to expose the apertures that will allow the escape of steam from the food.

### SUMMARY OF INVENTION

For the purpose of this patent application, the term “package” used throughout at the specification includes all kind of the object containers which fall within the scope of the of the claims, i.e. pouch, packaging, and any other relevant containers. It is to be understood that the use of the term is not limiting the scope of the claims to certain designs and/or embodiments of the package according to the invention.

Accordingly, the current invention relates to a package with flexible films to form an openable sealing means. In particular, the invention relates to a package with flexible films to form an openable sealing means for containing food which are intended to be heated by microwave ovens. The current invention is a simpler and a more convenient solution to contain the food by packaging that will enable the prepared food to be heated without the need of puncturing the packaging prior to heating.

In this specification, the term “strip” intended to include all physical shapes of the film, whether in an elongated strip spanning a package or a piece small enough to be sealed within the sealing edges of the package sheet, and includes any shape of such piece, such as arrow tip, triangular or tapering shapes

The strip on the packaging is sealed or welded to the packaging in such a way that during the heating of the prepared packaged food, the point of welding will automatically rupture, thus allowing the expanded steam to, escape without the food spattering. This simplified approach would ensure that the intended moisture contained therein would be retained and hence, the packaged food will not be dried or rendered unpalatable. Hence and unlike previous patents, there is no necessity for the consumer to peel off any layer from the packaging, nor to puncture the packaging at any stage. Another major advantage in the manufacturing of the laminated films for such packaging is the simplicity of not having to contend with the required amount of perforation/aperture for perfect reheating so that the prepared food is palatable.

In one aspect of the invention, it is provided a packaging sheet comprising at least 2 layers of laminates enclosing an object to be packaged in an edge-to-edge sealing wherein a portion of the sealable edge may be made frangible to vent internal pressure increase by providing a piece of a first material predisposed to be sealed at said portion of said packaging sheet edge, wherein said piece of first material is different from the second material forming at least one of the inner layer of the packaging sheet laminates, and whereby the seal is formed by thermal means. The term “edge-to-edge sealing” is used in this specification to refer to the all-round sealing along the marginal edge of a packaging sheet as it is folded to enclose an object.

Upon thermal sealing, preferably, the piece of first material forms with the second material of at least one of the inner layer a lamination that is weaker relative to the lamination formed between two adjacent inner layers' second, i.e. same, material.

In one preferred embodiment, the piece of first material comprises a piece of thin film provided in a suitable shape to be predisposed for sealing at the portion of the sealable edge. Preferably, the piece of thin film is provided as a strip predisposed to span opposing edges of the sealed package. Alternatively, the piece of first material is provided as an extended flange from the portion of the sealable edge, and wherein said flange is back-foldable to be sealed within the edges of the packaging sheet.

In a preferred embodiment, the piece of first material is a single layer formed by film extrusion. The piece of first material may be predisposed in a packaging sheet according to any one of the preceding claims, including that in bulk forms of strips, rolls, and dispensable pieces. Alternatively, the piece of first material includes a multi-layered strip.

In a second aspect of the invention, a package may be formed from a packaging sheet according to the preceding embodiments, including a microwaveable package. The strip and a main body may also comprise of at least two layers.

In a preferred embodiment, the material of the innermost layer of the said multi-layered main body that is overlaying and sealed to the uppermost layer of the said multi-layered strip is the same as that of the said uppermost layer of the said multi-layered strip. Preferably, the multi-layered main body underlay is sealed at its edges to the edges of both the said multi-layered strip and the said multi-layered main body that is overlaying the said multi-layered strip.

In another preferred embodiment, the material of the bottommost layer of the said multi-layered strip that is in contact and sealed at the edges to the edges of the innermost layer of the said underlaying multi-layered main body is different from the material of the said innermost layer of the underlaying multi-layered main body. Preferably still, the material is selected from any one or in combination of polyethylene and its derivatives, polyester and its derivatives, polypropylene and its derivatives or nylon and its derivatives and the package includes any one of a centre-sealed flexible package, a three-side sealed flexible package, a gusset package and a standing package.

Preferably, the layers of the said multi-layered strip and said multi-layered main body are sealed or laminated together by means of adhesion using a suitable adhesive or by extrusion with organic additives. The sealing of the multi-layered strip to its overlaying multi-layered main body is by means of adhesion using suitable adhesive or extrusion with organic addictives or heat sealing or RF or ultrasonic or similar welding. Similarly, the said sealing of the edges of the said underlaying multi-layered main body to the edges of the said multi-layered strip and its overlaying multi-layered main body are by means of heat sealing or RF or ultrasonic or similar welding. The strip may generally be constructively positioned in any configured package that would ensure a designated area of weakness to internal pressure increase due to the heat sealing of differing material.

In another aspect of the invention, it is provided a package for containing food having a sealing means, wherein said package and said sealing means are made from a material suitable for heating, said sealing means comprising a sheet of multi-layered strip and a sheet of multi-layered main body overlaying and sealed to the said multi-layered strip; wherein the package underlaying and sealed to the said multi-layered strip and multi-layered main body and wherein when the package is heated in a heating means, water contents of the food will be transformed into steam, thus increasing pressure in the package, the pressure will rupture the designated area of weakness and creates an exit to allow the steam to escape therethrough. Preferably the package is microwaveable and the heating means is microwave.

In a specific embodiment, both the said multi-layered strip and main body consists of at least two layers. Preferably, the material of the innermost layer of the said multi-layered main body that is overlaying and sealed to the uppermost layer of the said multi-layered strip is the same as that of the said uppermost layer of the said multi-layered strip. Preferably, the multi-layered main body underlay is sealed at its edges to the edges of both the said multi-layered strip and the said multi-layered main body that is overlaying the said multi-layered strip.

In one preferred embodiment, the material of the bottommost layer of the said multi-layered strip that is overlaying and sealed at the edges to the mouth region of the said package is different from the material of the said mouth region of the package. Preferably, the package is constructed using a material suitable for heating under a microwave, including a material selected from polyethylene and its derivatives, polyester and its derivatives, polypropylene and its derivatives or nylon and its derivatives.

In an alternative embodiment, the layers of the said multi-layered strip and said multi-layered main bodies are sealed or laminated together by means of adhesion using a suitable adhesive or by extrusion with organic additives. Preferably, the sealing of the multi-layered strip to its overlaying multi-layered main body is by means of adhesion using suitable adhesive or extrusion with organic additives or heat sealing or RF or ultrasonic or similar welding.

Preferably, the said sealing of the said package to the multi-layered strip and its overlaying multi-layered main body is by means of heat sealing or RF or ultrasonic or similar welding. Alternatively, the strip can be constructively positioned in any configured package that would ensure a designated area of weakness due to the heat sealing of differing material.

Embodiments of the invention will appear more clearly in the following description with reference to the accompanying drawings.

### BRIEF DESCRIPTION OF DRAWINGS

FIG. 1 is the top view a centre-sealed flexible pouch of the current invention according to the preferred embodiment of the invention, showing the strip on the pouch.

FIG. 2 shows the cross-section of the centre-sealed pouch of the current invention according to the preferred embodiment of the invention, illustrating the layers in the main body and the strip.

FIG. 3 is the perspective view of the centre-sealed flexible pouch of the current invention according to the preferred embodiment of the invention showing the strip and the area of weakness on the pouch.

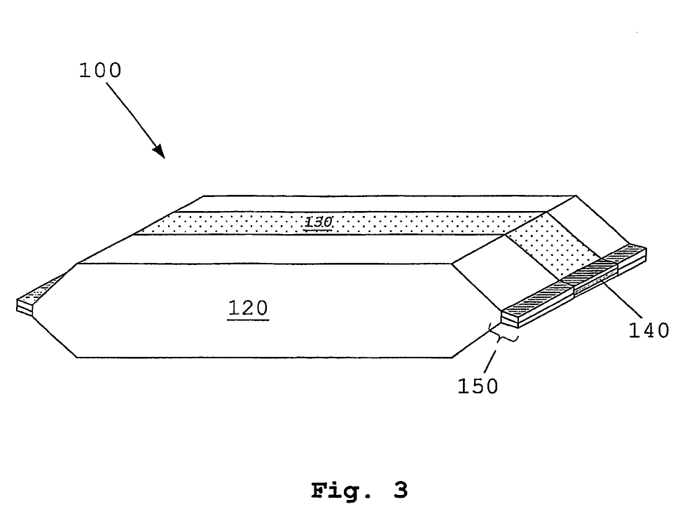

FIG. 4 is the perspective view of the centre-sealed flexible pouch of the current invention according to the preferred embodiment of the invention showing the strip and ruptured area on the pouch.

FIG. 5 shows perspective view of a 3-side sealed pouch, illustrating the sealing of the sheets to form a 3-side sealed pouch and also illustrating the absence of the third layer of the current invention according to the preferred embodiment of the invention.

FIG. 6 is the perspective view of the 3 side-sealed pouch of the current invention according to the preferred embodiment of the invention.

FIG. 7 is the cross section of the pouch at the sealed edges, illustrating the area of weakness in the pouch of the current invention according to the preferred embodiment of the invention.

FIG. 8 is cross section of the pouch at the sealed edges, illustrating the area of weakness in the pouch without the third layer of the current invention according to the preferred embodiment of the invention.

FIG. 9 is the perspective view of a gusset pouch with the strip of the current invention according to the preferred embodiment of the invention.

FIG. 10 is the perspective view of a standing pouch of the current invention according to the preferred embodiment of the invention with the strip.

FIG. 11 is the perspective view of a top-sealed container of the current invention according to the preferred embodiment of the invention.

FIG. 12 is the perspective view of a centre-sealed pouch with more than one sheet of the strip of the current invention according to the preferred embodiment of the invention.

### DETAILED DESCRIPTION OF THE DRAWINGS

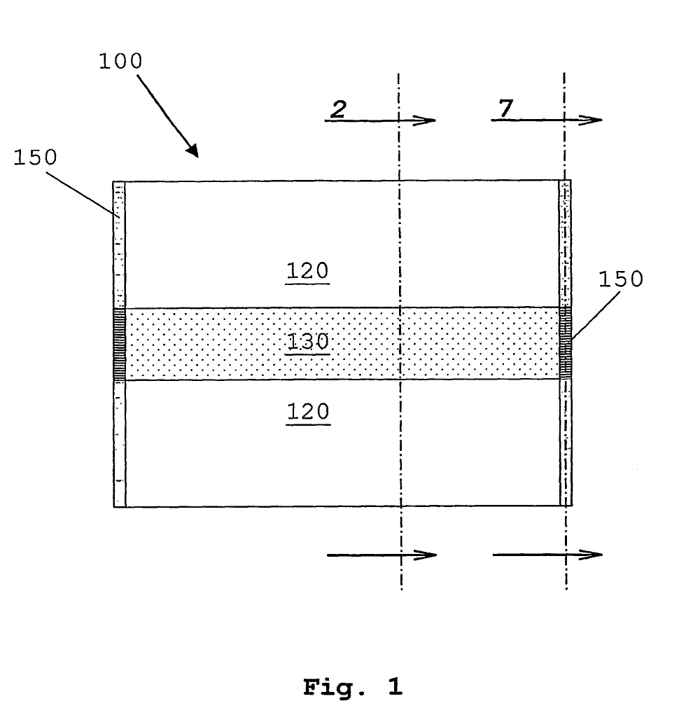

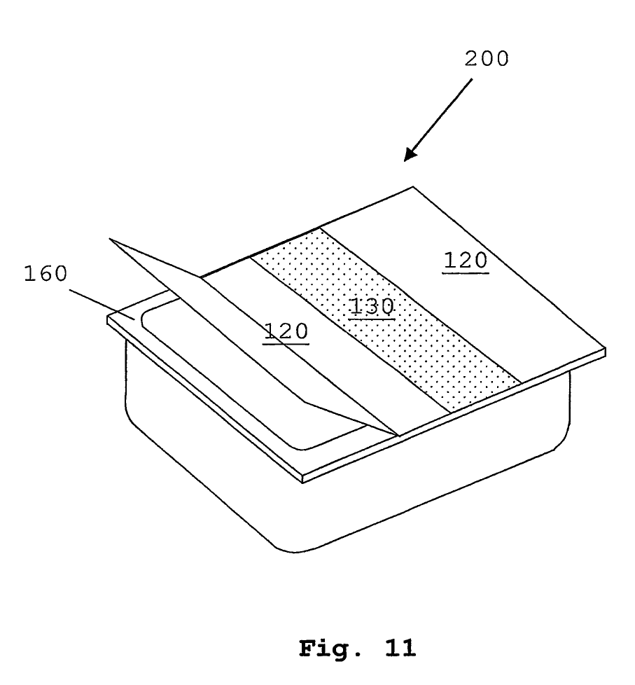

FIG. 1 shows the top view of a centre-sealed pouch (100) which is one form of the preferred embodiment of the current invention. The other embodiment of the current invention is shown in FIG. 11, which shows a perspective view of a top-sealed container (200). Both form of the current invention consists of the multi-layered main body (120) and the multi-layered strip (130).

With reference to FIG. 1 of the current invention, the pouch (100) is made by sealing the strip (130) in between two sheets of the main body (120) to form one continuous sheet, which is then sealed at the parallel edges or sides to produce the sealing ends (150) in order to contain the prepared food within. The sealing of the edges is now described in detail.

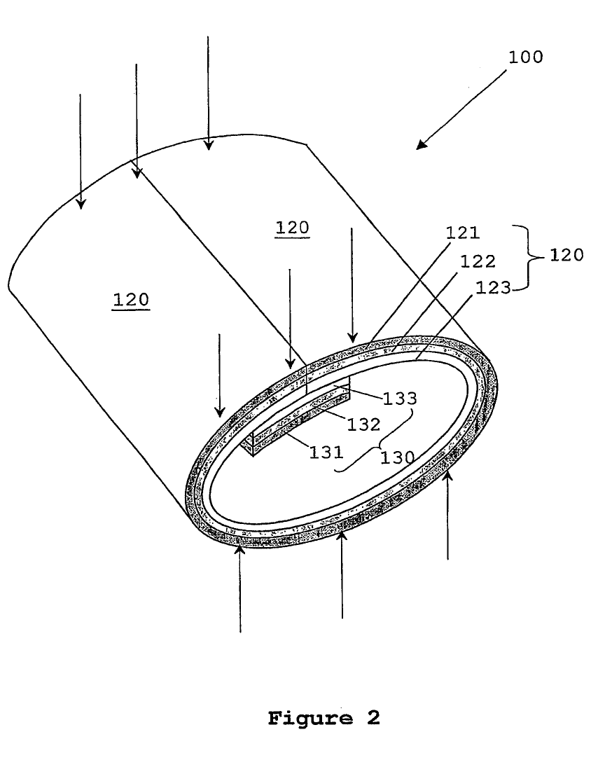

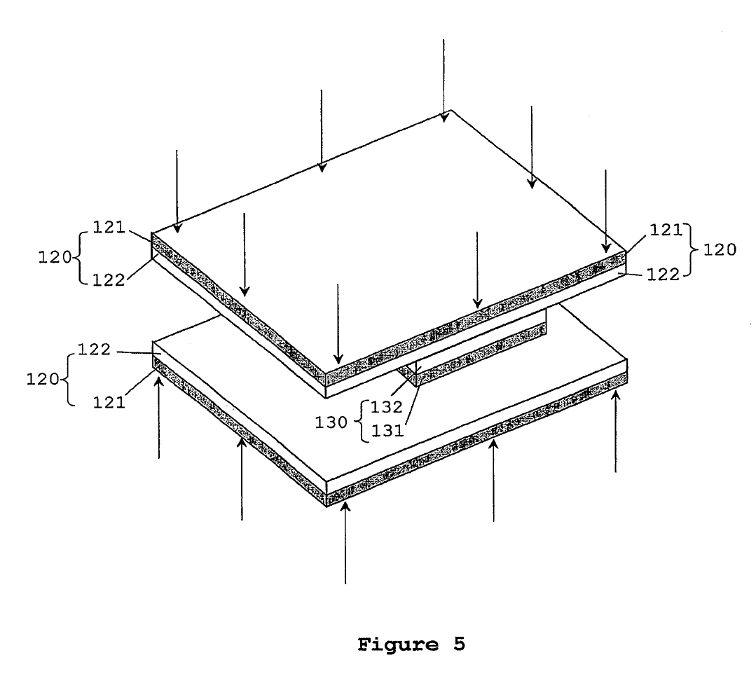

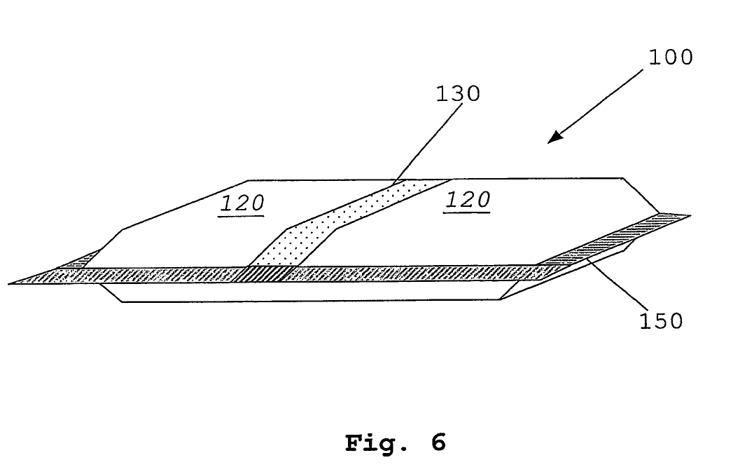

FIG. 2 figuratively shows how the sealing is done at the parallel edges or sides to give sealing ends (150). The parallel edges or sides, which are pointed by the arrows, are to be sealed together in the direction of the arrows to give the sealing ends (150). FIG. 5 shows another method of sealing the sheets together to form a three-side sealed pouch (see FIG. 6). In this figure, it can be clearly seen that there are two separate sheets; one top consisting of the multi-layered main body (120) and multi-layered strip (130), and one bottom consisting of only the main body (120), and these two sheets are to be sealed at the parallel edges or sides which are pointed by the arrows so that the prepared food is contained. The edges are sealed in the direction of the arrows to produce the sealing ends (150). Note that the lower main body (120) in this diagram is inverted when compared to the upper main body (120). Sealing of the edges to produce sealing ends (150) is done by means of heat sealing or RF or ultrasonic or similar welding.

FIG. 2 also shows the cross section of the food pouch (100). Both the main body (120) and the strip (130) of the present invention consist of first layer (121; 131), a second layer (122; 132), and possibly a third layer (123; 133). However in a broad sense, the main body (120) and the strip (130) may consists of only first layer (121; 131) and second layer (122; 132) wherein the third layer (123; 133) is absent (see FIG. 5) or may consists of more than three layers. In this configuration, substantially all of the features that have been described herein and are made with reference to the first layer (121; 131) and second layer (122; 132) with the presence of the third layer (123; 133).

For FIG. 2, the outermost or first (121), second (122) and the innermost or third layer (123) of the main body (120) can be made of either polyethylene and its derivatives, polyester and its derivatives, polypropylene and its derivatives, nylon and its derivatives or any material suitable for heating by microwave oven. All three layers are sealed or laminated to one another or together by means of adhesion using a suitable adhesive or by extrusion with organic addictives.

For the same figure, the bottommost or first layer (131) of the strip (130) is made of the same material selected for the outermost or first layer (121) of the main body (120). The uppermost or third layer (133) of the strip (130) is also made of the same material selected for the innermost or third layer (123) of the main body (120). The second layer (132) of the strip (130) can be made of any of the mentioned materials; i.e. polyethylene and its derivatives or polyester and its derivatives or polypropylene and its derivatives or nylon and its derivatives or any material suitable for heating by microwave oven and is not necessarily made of the same material selected for the second layer (122) of the main body (120). All three layers are sealed or laminated to one another or together by means of adhesion using a suitable adhesive or by extrusion with organic addictives.

For FIG. 5 which shows the cross-section of the pouch (100) of the present invention with the absence of the third layer (123 & 133), the first (121) and second (122) layer of the main body (120) can be made of either polyethylene and its derivatives, polyester and its derivatives, polypropylene and its derivatives, nylon and its derivatives or any material suitable for heating by microwave oven. All layers are sealed or laminated to one another or together by means of adhesion using a suitable adhesive or by extrusion with organic addictives.

Similarly, with reference to the same figure, the bottommost or first layer (131) of the strip (130) is made of the same material selected for the outermost or first layer (121) of the main body (120). The uppermost or second layer (132) of strip (130) is also made of the same material selected for the innermost or second layer (122) of the main body (120). All layers are sealed or laminated to one another or together by means of adhesion using a suitable adhesive or by extrusion with organic addictives. The latter technology of sheet extrusion is known in the art and may be employed to produce the strip in a single layer. The multi-layered strip (130) can be made into a single layer strip by extrusion process.

From FIGS. 2 and 5, it can be seen that the strip (130) is underlaying the main body (120). For FIG. 2, the uppermost or third layer (133) of strip (130) is sealed to the innermost or third layer (123) of the main body (120) and for FIG. 5, the uppermost or second layer (132) of strip (130) is sealed to the innermost or second layer (122) of the main body (120). Sealing is done by adhesion using suitable adhesive or extrusion with organic addictives or heat sealing or RF or ultrasonic or the like welding. The pouch is then sealed at the edges by means of heat sealing or RF or ultrasonic or similar welding to produce the sealing ends (150) so that the prepared food can be contained within.

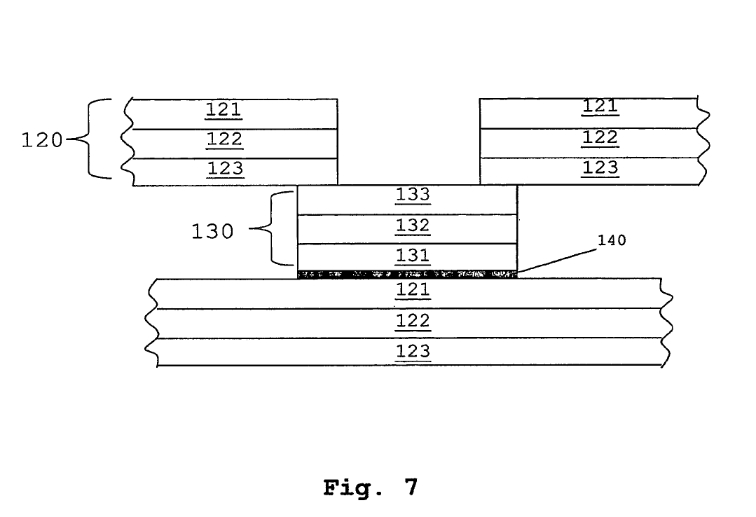

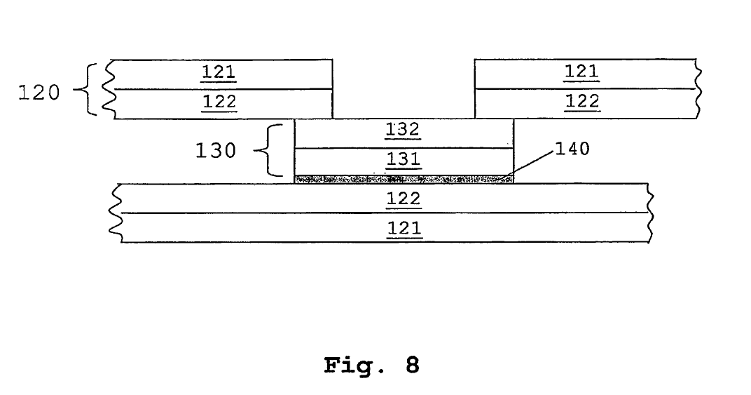

FIGS. 7 and 8 shows the cross section of the sealing ends (150). The bottommost or first layer (131) of the strip (130) is now overlaying and sealed by means of heat sealing to the innermost or third layer (123) of the main body (120) for FIG. 7, or the innermost or second layer (122) of the main body (120) for FIG. 8. This heat sealing is done between two different materials, i.e. the bottommost or first layer (131) of the strip (130) with the innermost or third layer (123) of the main body (120) for FIG. 7, or with the innermost or second layer of the main body (120) for FIG. 8. Both the figures are simplified only to show the heat sealing of the bottommost or first layer (131) of the strip (130) with the innermost layer of the main body. Although it is shown in both FIGS. 7 and 8 that the innermost layers of both the main bodies (120) are separated, the innermost layers of both the main body (120) are actually sealed together.

Sealing by means of adhesion using a suitable adhesive or by extrusion with organic addictives is stronger than the sealing done by means of heat sealing or RF or ultrasonic or the like welding. Heat, sealing two layers of the same material together creates a stronger bond between the two layers when compared to the heat sealing between two layers of different material. Due to the weak bond that is created during heat sealing, the area of sealing between two different material creates an area of weakness (140) and it is this area of weakness that enables the steam to escape and how the steam escapes will be described later.

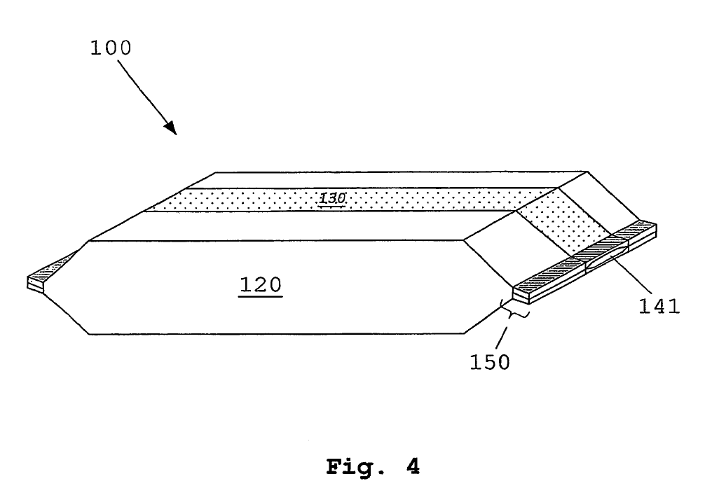

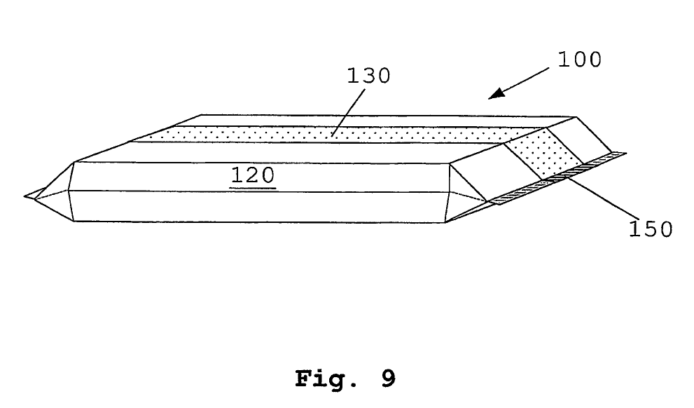

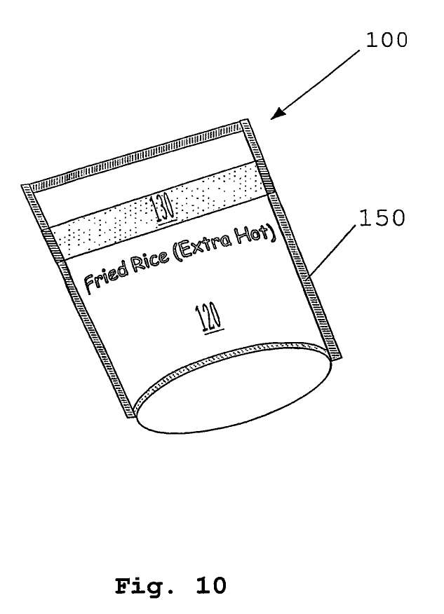

The packaging is not only limited to centre-sealed flexible pouch. Other forms of packaging can also be used with the current invention as shown in FIGS. 4 and 5 which is a 3-side sealed flexible pouch. The invention is not only limited to flexible pouch. It can also be used for gusset pouch (FIG. 9) and standing pouch (FIG. 10) and also top-sealed food containers (FIG. 11).

A top-sealed food container (200) is shown in FIG. 11. In this figure, the mouth region defined by a rim of the walls of the container is a flanged rim which present a surface (160) onto which the top-seal can be conveniently sealed. The strip (130) is sealed to the main body (120) as previously described, wherein the innermost layer of the main body (120) is sealed by adhesive means or extrusion with organic addictives or heat sealing or RF or ultrasonic or the like welding to the uppermost layer of the strip (130) which is of the same material. The third layer (123) of the main body (120) is sealed by heat sealing or RF or ultrasonic or the similar welding to the rim or the container and the third layer (123) of the main body (120) and is made of the same material as the container or the mouth region of the container. Hence, the first layer (131) of the strip (130) is sealed to the rim of the container which is made of the same material as the third layer (123), and due to fact that the three layers in contact are of different material, an area of weakness (140) is created. The bond between the first layer (131) of the strip (130) and the rim of the container [Which is made of the same material as the third layer (123) of the main body] that is created during heat sealing is weak.

The function of having the strip (130) in the main body (120) shall now be further described in detail.

When the package is being heated in a microwave oven, the water contained in the food is heated very rapidly and is transformed into steam. As the temperature within the package increases during heating, the steam will expand and hence the pressure within the package increases. Before the pressure within the package is increased greatly, the pressure of the expanded steam will rupture the designated area of weakness (140) of the package, to create an exit (141) (see FIG. 4) to allow the steam to escape through without spattering the food. The existence of the area of weakness (140) allows rupturing of the package to occur without having the pressure of the steam within the package being too great, thus preventing the food to spatter. It is the weak bond that is created between two different material when the two are sealed together during heat sealing that creates an area of weakness which is not able to withstand the pressure of the steam that is contained within the package. The bond that is created during heat sealing between two layers of the same material is stronger to withstand the pressure of the steam without rupturing as compared to the designated area of weakness.

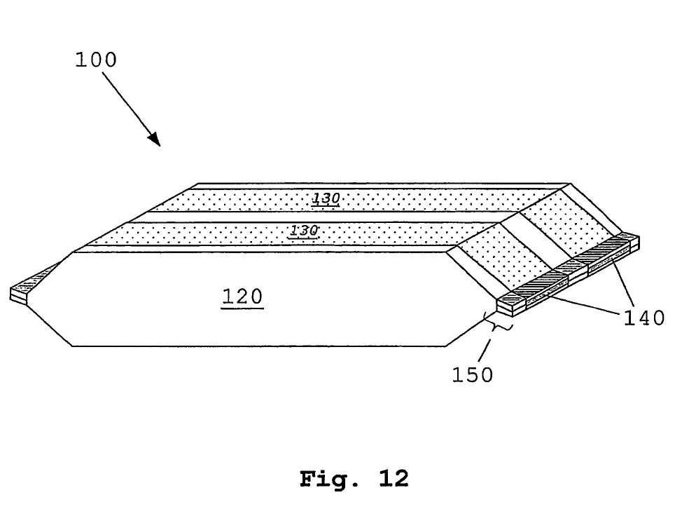

The present invention is not only limited to a package having only one sheet of strip (130). A package can contain more than one sheet of strip (130). FIG. 12 is an example of a package with more than one sheet of strip (130) whereby a centre-sealed pouch with 2 sheets of strip illustrated. The strip (130) can also be of any shape and size.

It will be understood that the present invention has been described above purely by way of example. Equally, the placement of strip is not limited as thus far described by any of these figures since the principal invention is to provide a weaker bond on the designated sealing area by such construction described above. Modifications of detail can be made within the scope of the invention.

We claim:

1. A sealed package that encloses an object, the package comprising:
a first thermoplastic material; and
a second thermoplastic material that is different from the first thermoplastic material, wherein a first seal is formed between the first thermoplastic material and the second thermoplastic material and a second seal is formed between two portions of the first thermoplastic material, wherein the first thermoplastic material and the second thermoplastic material in conjunction with the first seal and the second seal define the sealed package that encloses the object;
wherein the first and second seal are created by thermal fusion; and
wherein the first seal is weaker than the second seal;
whereby upon a predetermined increase of an internal pressure in the sealed package compared to an external pressure outside the sealed package, the first seal ruptures to relieve the internal pressure from the sealed package but the second seal does not rupture.

2. The sealed package of claim 1, wherein neither the first thermoplastic material nor the second thermoplastic material has any perforation or other weakness to assist in the opening of the sealed package.

3. The sealed package of claim 1, wherein at least one of the first thermoplastic material and the second thermoplastic material comprises a multi-layer structure.

4. The sealed package of claim 1, wherein the first seal and second seal are formed by heat sealing, RF welding, ultrasonic welding or combinations thereof.

5. The sealed package of claim 1, wherein the first thermoplastic material and the second thermoplastic material are selected from polyethylene and its derivatives, polyester and its derivatives, polypropylene and its derivatives, nylon and its derivatives or any polymer and its derivatives.

6. The sealed package of claim 1, wherein the sealed package comprises a center-sealed flexible package, a three-side sealed flexible package, a gusset package, a stand-up pouch or toplidding for tray.

7. A sealed package that encloses an object, the package comprising:
a first thermoplastic sheet material;
a second thermoplastic sheet material that is different from the first thermoplastic material;
wherein at least one piece of the first thermoplastic material wraps the object such that edge portions of the first thermoplastic material can contact each other;
wherein the second thermoplastic material is disposed between two edge portions of the first thermoplastic material;
wherein a first seal is formed between the first thermoplastic material and the second thermoplastic material;
wherein a second seal is formed between remaining edge portions of the first thermoplastic material to thereby enclose the object;
wherein the first and second seals are formed in one thermal sealing process;
wherein the first seal is weaker than the second seal; and
whereby upon a predetermined increase of an internal pressure in the sealed package compared to an external pressure outside the sealed package, the first seal ruptures to relieve the internal pressure from the sealed package but the second seal does not rupture.

8. The sealed package of claim 7, wherein at least one of the first thermoplastic material and the second thermoplastic material comprises a multi-layer structure.

9. The sealed package of claim 7, wherein the first thermoplastic material and the second thermoplastic material are selected from polyethylene and its derivatives, polyester and its derivatives, polypropylene and its derivatives, nylon and its derivatives or any polymer and its derivatives.

10. A sealed package that encloses an object, the package comprising:
a first side panel, a second side panel and a bottom panel all made of first thermoplastic material;
a second thermoplastic material that is different from the first thermoplastic material;
wherein the second thermoplastic material disposed between two edge portions of the first side panel and the second side panel;
wherein a first seal is formed between the first thermoplastic material of the first side panel and the second side panel and the second thermoplastic material;
wherein a second seal is formed between remaining edge portions of the first side panel, the second side panel and the bottom panel to define the sealed package that encloses the object;
wherein the first seal is weaker than the second seal; and
whereby upon a predetermined increase of an internal pressure in the sealed package compared to an external pressure outside the sealed package, the first seal ruptures to relieve the internal pressure from the sealed package but the second seal does not rupture.

11. The sealed package of claim 10, wherein the first and second seals are formed in one thermal sealing process.

12. The sealed package of claim 10, wherein at least one of the first thermoplastic material and the second thermoplastic material comprises a multi-layer structure.

13. The sealed package of claim 10, wherein the first thermoplastic material and the second thermoplastic material are selected from polyethylene and its derivatives, polyester and its derivatives, polypropylene and its derivatives, nylon and its derivatives or any polymer and its derivatives.

14. A sealed package that encloses an object, the package comprising:
a top panel fabricated from a first thermoplastic material;
a container having a rim extending around an opening thereof, wherein at least a rim of the container is fabricated from the first thermoplastic material;
a second thermoplastic material disposed between two edge portions of the top panel and the container proximate the rim;
wherein the second thermoplastic material is different from the first thermoplastic material;
wherein a first seal formed between the first thermoplastic material of the top panel, the container proximate the rim and the second thermoplastic material;
wherein a second seal formed between edge portions of the top panel and the container proximate the rim to define the sealed package that encloses the object;
wherein the first seal is weaker than the second seal; and
whereby upon a predetermined increase of an internal pressure in the sealed package compared to an external pressure outside the sealed package, the first seal ruptures to relieve the internal pressure from the sealed package but the second seal does not rupture.

15. The sealed package of claim 14, wherein the first and second seals are formed in one thermal sealing process.

16. The sealed package of claim 14, wherein the container has a rim extending around the opening, and wherein the top panel is attached to the container proximate the rim.

17. The sealed package of claim 14, wherein at least one of the first thermoplastic material and the second thermoplastic material comprises a multi-layer structure.

18. The sealed package of claim 14, wherein the first thermoplastic material and the second thermoplastic material are selected from polyethylene and its derivatives, polyester and its derivatives, polypropylene and its derivatives, nylon and its derivatives or any polymer and its derivatives.

19. A method of packaging an object in a sealed package, a part of the seal of which package automatically ruptures upon a predetermined increase of internal pressure, the method comprising:
providing a first thermoplastic sheet material and a second thermoplastic sheet material that is different from the first thermoplastic material;
wrapping the object in at least one piece of the first thermoplastic material such that edge portions of the first thermo plastic material can contact each other;
placing the second thermoplastic material between the edge portions of the first thermoplastic material;
forming a first seal between the first thermoplastic material and the second thermoplastic material;
forming a second seal between unsealed edge portions of the first thermoplastic material,
wherein the first thermoplastic sheet material and the second thermoplastic sheet material in conjunction with the first seal and the second seal thereby enclose the object in a sealed package;
wherein the first seal is weaker than the second seal; and
wherein the sealed package, being such that heating of the sealed package increases an internal pressure in the sealed package compared to an external pressure outside the sealed package, and causes at least a portion of the first seal to rupture, thereby releaving the internal pressure from the sealed package, but the second seal does not rupture.

20. The method of claim 19, wherein the first and second seals are formed in one thermal sealing process.

21. A method of heating an object in a sealed package, the method comprising:
providing a first thermoplastic sheet material and a second thermoplastic sheet material that is different from the first thermoplastic sheet material;
wrapping the object in the first thermoplastic sheet material such that edge portions of the first thermoplastic sheet material can contact each other;
placing the second thermoplastic material between the edge portions of the first thermoplastic material;
forming a first seal between the first thermoplastic material and the second thermoplastic material;
forming a second seal between unsealed edge portions of the first thermoplastic material, wherein the first seal is weaker than the second seal and wherein the first thermoplastic sheet material and the second thermoplastic sheet material in conjunction with the first seal and the second seal enclose the object; and
heating the sealed package which causes an internal pressure in the sealed package to increase when compared to an external pressure outside the sealed package, and such increase in the internal pressure causes at least a portion of the first seal to rupture, thereby releaving the internal pressure from the sealed package, but the second seal does not rupture.
